(19) United States
(12) Patent Application Publication
(10) Pub. No.: US 2022/0170701 A1
(43) Pub. Date: Jun. 2, 2022

(54) APPARATUS FOR EXCHANGING HEAT AND MATERIAL

(71) Applicant: L'Air Liquide, Société Anonyme Pour l'Etude et l'Exploitation des Procédés Georges Claude, Paris (FR)

(72) Inventors: Eric MASLIAH, Brunoy (FR); Camille MARIE, Paris (FR); Ludovic AMANT, Vaires sur Marne (FR); Patrick LE BOT, Vincennes (FR); David FRIMAT, Paris (FR); David BEDNARSKI, Bures sur Yvette (FR); Jean-Pierre TRANIER, L'Hay-les-Rosas (FR)

(21) Appl. No.: 17/433,548

(22) PCT Filed: Feb. 25, 2020
(86) PCT No.: PCT/FR2020/050350

§ 371 Date: Aug. 24, 2021

(30) Foreign Application Priority Data
Feb. 25, 2019 (FR) 1901868
Feb. 25, 2019 (FR) 1901869
Feb. 25, 2019 (FR) 1901872

(51) Int. Cl. F28D 21/00; F25J 5/00; F25J 3/04; F28F 21/08; B01J 19/32

(52) U.S. Cl. CPC F28D 21/0015; F25J 5/007; F25J 3/0463; F28F 21/08; B01J 2219/32272; F25J 2200/04; F25J 2290/44; B01J 2219/32213; B01J 19/32

(57) ABSTRACT

A direct heat exchange and material transfer apparatus having a plurality of columns, a single stack of at least two solid metal plates of rectangular section, the plates being substantially all of the same shape and dimensions and parallel to a determined direction, each plate being separated from the adjacent plate, at least in a first direct heat exchange and material transfer zone of the apparatus, by a group of hollow metal columns that are aligned and have a section which is polygonal and has at least two parallel surfaces, the channels being parallel to the determined direction and contiguous with one another, the columns of each group each being in contact with the two metal plates on either side of the group, at least some of the columns of a group containing a material and heat exchange means.

### CROSS REFERENCE TO RELATED APPLICATIONS

This application is a 371 of international Application No. PCT/FR2020/050350, filed Feb. 25, 2020, which claims priority to French Patent Application Nos. 1901868, 1901869, and 1901872, all filed Feb. 25, 2019, the entire contents of which are incorporated herein by reference.

### BACKGROUND

The present invention relates to an apparatus for direct heat exchange and material transfer, in particular between a gas and a liquid.

Equipment for direct heat exchange and material transfer is today used in a wide variety of processes. For example, material transfer columns allow scrubbing processes, mixing processes, cooling processes, heating processes or distillation processes to be implemented. All of these processes are based on a single basic principle, namely direct contact between at least two fluids. These two fluids are preferably a gas and a liquid but could be two liquids or two gases.

Such columns thus comprise at least one direct heat exchange and material transfer medium, which the two fluids pass through counter-currently or co-currently and in which the material transfer and the direct heat exchange between these two fluids take place.

In a distillation process, a gaseous or two-phase feed flow is sent to a direct heat exchange and material transfer column, this column being heated at the bottom and/or cooled at the top so as to establish, in a column, a series of successive steps of condensation and vaporization of the flow sent to the column. This results in a gas flow that rises in the column, becoming enriched in at least one lighter component of the feed flow, counter-current to a liquid flow that descends in the column under gravity, becoming enriched in at least one heavier component of the feed flow.

In a scrubbing process, a gaseous or two-phase feed flow is sent to a direct heat exchange and material transfer column, this column also being fed at the top by a liquid that selectively absorbs one or more components of the feed flow. This results in a gas flow that rises in the column, becoming depleted in selectively absorbed component(s), counter-current to a liquid flow that descends in the column, becoming enriched in selectively absorbed component(s).

In a rectification process using the heat generated when two phases mix, known as a mixing process, a liquid feed flow is sent to the top of a column and a gaseous feed flow is sent to the bottom, the product of the process being withdrawn in the middle of the column, as described in FR2143986, FR2584803 and other patents classified in CPC F25J3/0446 and F25J3/04466.

Usually, direct heat exchange and material transfer equipment is manufactured by disposing corrugated lamellae, which are grouped together in blocks so as to form structured packings, inside a cylindrical shell. The method may be slow and expensive, due to the dimensions of the columns and also due to the complexity of the manufacture and installation of the packings. Moreover, when the fluids used are at cryogenic temperature, aluminum is a material suited to the manufacture of the packings, or even of the shell of the column.

Since structured packings require a whole manufacturing line, it is not possible to precisely adapt these packings to the heat and/or material exchange that they have to perform.

For example, only certain densities, certain corrugation angles and certain pleat heights will be available. In addition, the packings are voluminous and difficult to store.

It is also known for a heat exchanger body to be produced by forming a stack of rectangular plates, which are separated by perforated fins, and subsequently brazing the stack so as to form a body having a plurality of passages.

This type of body is subsequently used to transfer heat indirectly from one fluid to the other, the fluid in a passage with fins transferring its heat through the plate to the adjacent passage with fins or through plates to the adjacent passages with fins.

In this case, there is no material transfer between the two fluids. The ALPEMA standard “The standards of the brazed aluminum plate-fin heat exchanger manufacturers' association” describes these indirect heat exchangers for indirect heat exchange between two or more fluids, which are made of brazed aluminum.

This brazing is a permanent assembly process that establishes a metallic bond between the plates and the fins.

Although this type of body is frequently used as an indirect heat exchanger, it has never been used on an industrial scale for the separation of fluids at temperatures below 0° C. Aluminum is a material that is very well suited to this manufacturing method.

In the prior art, a cryogenic air separation unit generally comprises brazed-plate heat exchangers that form in particular the main heat exchange line of the cryogenic air separation unit and the vaporizer-condenser placing the medium-pressure column and the low-pressure column in a heat exchange relationship. These two distillation columns in which the material exchange is carried out are not incorporated into the brazed matrices that constitute these brazed-plate heat exchangers.

Patent EP0767352 proposes incorporating a dephlegmation function into these brazed matrices, i.e. a zone in which indirect heat exchange and material exchange and direct heat exchange are carried out simultaneously.

U.S. Pat. No. 6,295,839 proposes incorporating distillation and indirect heat exchange functions into a brazed matrix, but it does not describe how to design such a brazed matrix (also called a “core”) so as to have a solution that can be brazed and that has the necessary mechanical strength to withstand the operating pressure.

The scientific publication “The structured heat integrated distillation column”, Bruinsma O. S. L. et al., Chem Eng Res Des (2012) compares the performance of conventional corrugations of exchangers made of brazed aluminum as described in the ALPEMA document “The standards of the brazed aluminium plate-fin heat exchanger manufacturers' association” with brazed cross-corrugated packing in a matrix. In the case of the cross-corrugated packing, in order to ensure the mechanical strength, a 1 mm perforated separator sheet is inserted before brazing between the two corrugated sheets so as to braze the whole. The efficiency of the conventional corrugation is very poor, with a HETP (height equivalent to a theoretical plate) of about 1.4 meters. The efficiency of the cross-corrugated packing is better, with HETPs of between 0.2 and 0.4 meters.

Nevertheless, if it were desired to increase the efficiency of the packing, it would be necessary to increase the density thereof, typically beyond 1000 m2/m3 or even 1500 m2/m3 so as to have HETPs smaller than 100 mm. To this end, the height of the corrugations would change from 8-9 mm to 3-4 mm and would make it necessary to double the number of separator sheets.

### SUMMARY

The present invention aims to propose a direct heat exchange and material transfer apparatus which is efficient (for example making it possible to have HETPs smaller than 100 mm), which can withstand pressure, which is easy to manufacture at low cost and into which it is possible, in a preferential embodiment, to incorporate the indirect heat exchange.

In particular, the elements of the apparatus can be found easily and at low cost commercially in a wide range of dimensions and geometries. It is thus easy to adapt the elements to the specific operating conditions of the apparatus, such as the pressure, the temperature, and the composition of the fluids involved.

The elements of the apparatus can be pre-purchased and stored and combined in various ways so as to produce an apparatus that perfectly suits the needs of the customer with a reduced manufacturing time.

The first aim of the invention is to separate the functions of mechanical strength and of contact surface for the material transfer and the direct heat exchange, in particular between a rising gas and a liquid descending under gravity. Thus, the majority of this contact surface does not play a significant part in the mechanical ability to withstand pressure of the apparatus. This makes it possible, in the case of brazing, not to have to increase the number of separator sheets, while at the same time making it possible to use a stacked or random packing of high density, typically greater than 750 m2/m3 or even 1000 m2/m3.

It is also an aim of the invention to produce an apparatus that is particularly pressure resistant for the same amount of apparatus material. Specifically, using a plurality of packed columns makes it possible to better control the pressure thrusts, and to reduce the amount of material required. By using a plurality of packed columns in parallel, the hydraulic diameter of said columns is reduced.

Now, columns of small hydraulic diameter with a given packing (a few centimeters) are markedly more efficient than typical industrial columns that are between 1 and 10 meters in diameter.

If a column one meter in diameter is divided into a thousand columns in parallel, the hydraulic diameter of these columns is divided by the square root of 1000 and therefore changes to 32 cm.

It is also an aim of the invention to propose an apparatus having multiple functionalities combined in a single assembly of plates.

According to another subject of the invention, a direct heat exchange and material transfer apparatus is provided that is constituted by a plurality of columns, a single stack of at least two, preferably at least three, solid metal plates of rectangular section, the plates being substantially all of the same shape and dimensions and parallel to a determined direction, each plate being separated from the adjacent plate, at least in a first direct heat exchange and material transfer zone of the apparatus, by a group of hollow metal columns that are aligned and have a section which is polygonal and has at least two parallel surfaces, which is preferably rectangular, or even square, the channels being parallel to the determined direction and contiguous with one another, optionally all the columns of the apparatus being parallel to one another, the columns of each group each being in contact with the two metal plates on either side of the group, at least some of the columns of a group, or even of each group, or even all the columns of a group, containing a material and heat exchange means, for example a packing such as a random or structured metal packing.

According to other optional aspects:
the plates are secured to the columns by brazing or by adhesive bonding.
the columns are secured by brazing or by adhesive bonding.
the plates, the columns and optionally the material and heat exchange means are all formed i) of the same metal or ii) of the same alloy or iii) of alloys with the same main metal. It will be understood that the plates and/or the columns can bear a coating, for example of brazing material. The material of the plate and/or the column is that which is covered by the coating. The coating can vary from one plate or column to another.
the plates and/or the columns and/or the direct and/or indirect heat exchange and material transfer means and is/are made of one of the following metals: aluminum, stainless steel, nickel, copper or titanium.
the minimum dimension of an edge of the section of a column is greater than 2 cm and preferably greater than 4 cm.
the length of a plate is at least equal to 1 m, preferably at least equal to 2 m, or even at least equal to 4 m.
the first zone constitutes a part of the apparatus that is delimited by the width and the thickness of the stack and by a part of the length of the stack.
the apparatus comprises means for supplying at least two thirds of, preferably all, the columns of at least the first zone with the same fluid.
the apparatus comprises means for collecting the same fluid from at least two thirds of, preferably all, the columns of at least a first zone.
the stack comprises a second zone, which is an indirect heat exchange zone, constituted by a part of the apparatus that is delimited by the width and the thickness of the stack and by a part of the length of the stack, comprising means for supplying one in two of the passages between two plates with a fluid coming from the first zone and means for supplying the rest of the passages of the second zone with a calorigenic or refrigerant fluid in order to allow indirect heat exchange with this fluid.
the apparatus comprises a second direct heat exchange zone constituting a part of the apparatus that is delimited by the width and the thickness of the stack and by a part of the length of the stack and comprising means for supplying at least two thirds of, preferably all, the columns of a zone with the same fluid and/or means for collecting the same fluid from at least two thirds of, preferably all, the columns of a zone.

According to another subject of the invention, an apparatus for separation, for example by distillation or by scrubbing, for use at temperatures below 0° C., is provided, comprising a heat and material exchange apparatus as described above, the apparatus being oriented such that, in use, a liquid introduced into a column flows in each column under gravity, means for sending a fluid to be separated to the exchange body comprising at least two components, means for extracting, from at least one end of the apparatus, at least one separated fluid enriched in one of the components of the fluid to be separated, and means for insulating the exchange apparatus, for example an insulated chamber containing the exchange apparatus.

The separation apparatus can comprise two zones designed to operate at different pressures, the means for sending a fluid to be separated to the exchange body comprising at least two components being connected to a first zone, and the means for extracting, from at least one end of the apparatus, at least one separated fluid enriched in one of the components of the fluid to be separated being connected to a second zone designed to operate at a pressure lower than that of the first zone.

The invention can comprise a process for separating a gas mixture, such as air, using an apparatus as described above.

Using a multiplicity of columns containing means allowing direct heat and material transfer, the columns all or substantially all being supplied by a flow of the same fluid, makes it possible to perform separation and/or mixing of fluids, for example scrubbing and/or distillation.

The contact surface of the packings is much larger than the surface of the channels that contain them. These packings do not play a part in withstanding pressure since they are not mechanically connected to the walls of the channels.

The HETP of the packings is preferably smaller than 100 mm for mixtures of air gases at atmospheric pressure.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 is a schematic perspective view of a material and/or heat exchange apparatus manufactured according to the present invention;

FIG. 2 is a partial view, in horizontal cross section, of the material and/or heat exchange apparatus according to the invention;

FIG. 3 is a partial view, in horizontal cross section, of two material and/or heat exchange columns of an apparatus according to the invention;

FIG. 4 illustrates a cross section of the interior of a material and heat exchange apparatus according to the invention;

FIG. 5 illustrates an alternative arrangement of the columns of a zone of the apparatus according to the invention;

FIG. 6 illustrates various ways of constructing columns of a zone of the apparatus;

FIG. 7 illustrates an apparatus according to the invention.

### NOTATION AND NOMENCLATURE

In the remainder of the description, the terms “direct and/or indirect heat exchange and material transfer means” and “exchange means” will be used without distinction. Similarly, the terms “direct and/or indirect heat exchange and material transfer exchange apparatus” and “apparatus” will be used without distinction. A vertical direction corresponds to a main direction of extension of an apparatus according to the invention, when this apparatus is in a functional position, i.e. a position in which a direct and/or indirect heat and material exchange can take place.

### DETAILED DESCRIPTION OF PREFERRED EMBODIMENTS

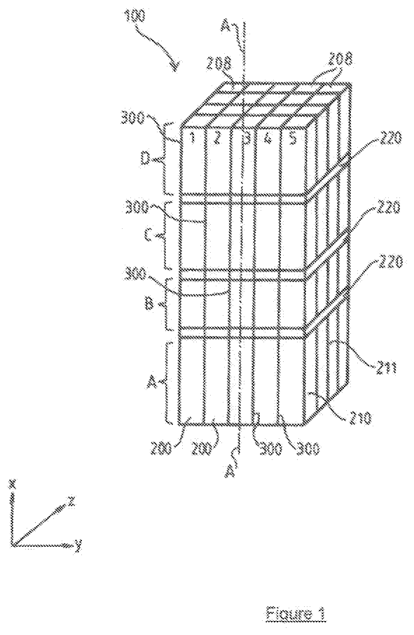

FIG. 1 thus illustrates a direct and indirect heat exchange and material transfer apparatus 100 according to the invention, in a method of assembly by brazing, which comprises three direct exchange and material transfer zones A, C and D and incorporates an indirect heat exchange zone B for indirect heat exchange of the vaporizer-condenser type. This apparatus comprises a plurality of at least two, or even at least three, preferably at least ten, flat plates 300 of rectangular section, and a plurality of direct heat exchange and material transfer columns 200. The flat plates 300 are the same shape and have the same dimensions. The plates can be solid, i.e. not perforated.

Now, a plate can be considered solid even if it comprises a number of localized perforations for allowing fluid to pass from one passage to the adjacent one, or for balancing the distribution of the liquid or the pressure drops on the gas side. The apparatus is in the form of a parallelepipedal block with a rectangular, or even square, section. The length of the apparatus is that of the plates along the axis X. Its width is that of the plates along the axis Z and its thickness depends on the number of plates and the dimensions along the axis Y of the material and/or heat exchange columns.

These plates 300 are disposed with their length vertical along the axis X and their width horizontal along the axis Z in use as a material and heat exchange means.

According to the example illustrated here, the apparatus comprises five flat plates 300 and eighty columns 200. A sixth flat plate 300 forming part of the stack normally has to cover the surface defined by the length of the apparatus and its width. This plate is not illustrated, for better perception of the construction of the apparatus.

The length of the plates 300 is at least equal to 1 m, preferably at least equal to 2 m, or even at least equal to 3 m.

The columns are disposed in three zones A, C, D, each zone comprising twenty columns disposed in five rows 1, 2, 3, 4, 5, each row comprising four columns. The columns 200 are all of identical construction, even though their dimensions can differ. In this case, each of the sixty columns has the same square section. The columns can all have the same rectangular section or simply the same section.

These columns are preferably columns that are readily commercially available and can be ordered in large quantities, at low cost and with dimensions and geometries corresponding to their role in the apparatus. This makes it possible both to standardize apparatuses so as to simplify their manufacture and reduce the costs thereof, and also to dimension other apparatuses with greater precision if the needs of the customer are more specific. In the direction Y, these columns typically have a dimension of a few centimeters, i.e. between 2 cm and 10 cm. In the direction Z, this dimension is also typically a few centimeters, or even a few decimeters.

The columns of a single zone A, C, D have the same length so as to form a parallelepipedal block of twenty columns 200.

In section B, in order to ensure indirect heat exchange of the vaporizer-condenser type, it is possible to divide the stack using spacer sheets 301 and to use conventional exchange corrugations as described by ALPEMA. The advantage of disposing the vaporizer-condenser in the apparatus, in addition to combining the functions, is to ensure a certain even distribution of the flows in the various passages (separated by the sheets 300), either by ensuring liquid reflux for zone A and by driving the flow of the gas in this passage by virtue of the condensation, or by ensuring the reboiling of zones C and D by partially vaporizing the liquid coming from zone C so as to ensure a rising gas flow in zones C and D. The number of passages in section B is preferably at least two passages so as to have, above each passage of zone A that is determined by the sheets 300, a passage in zone B performing condensation so as to supply zone A with liquid, and, below each passage of zone C, a passage in zone B performing vaporization so as to supply zone C with gas.

It will be understood that the zones can have different lengths depending on the functionality that they have to have, and the length of the columns is chosen depending on that of the zones.

The walls of the columns are preferably solid such that a fluid cannot pass through them.

The number of columns in each section may differ from one section to another. The columns are not necessarily of square section but can have a section that is rectangular, or even polygonal, for example triangular or of a polygonal shape with two parallel sides, for example octagonal.

Each column 200 is sandwiched between two flat plates 300, in contact with these two plates, hence the advantage of having a section with two parallel walls. It will be understood that flat plates 500 can be disposed on the faces of the columns on the right and on the left in FIG. 1 (in the plane (X, Z)) so as to close the apparatus, these plates not being illustrated so as to allow the interior structure of the apparatus to be seen.

Alternatively it is possible to increase the thickness of the flat plates 300 situated on the outside of the apparatus so as to make the apparatus more robust.

Each space between a pair of adjacent plates 300 contains an alignment 208 of four columns 200 that touch along the axis Z.

There will also optionally be bars 400 for closing the spaces between the plates 300 on the front and at the rear of the apparatus 100, but these would prevent the columns 200 from being seen and are therefore not illustrated here.

Nevertheless, it is conceivable that the bars 400 are not present, and that the sealing is ensured by the columns themselves or by another means, such as glue.

In this figure, as each column has the same section and each zone comprises the same number of columns, it is easy to arrange each column 200 of a row directly below the column of the zone above.

Each column is in contact with one other column, if it is located at the end of a row, or with two other columns.

The description that will be given below of one of them applies, mutatis mutandis, to all of the constituent columns 200 of the apparatus 100 illustrated in FIG. 1.

According to the example illustrated here, the apparatus 100 is shown in its operating position. “Operating position” is understood to mean a position in which the apparatus 100 can be used. Each column 200 has a main axis of extension parallel to the main direction of extension X of the material and/or heat exchange apparatus 100. When the apparatus 100 is in a vertical position, i.e. its operating position, this main axis X of extension is a vertical axis. It is understood that this is only one exemplary embodiment of the present invention and that the apparatus 100 and the constituent columns 200 of this apparatus 100 could have a different shape without departing from the context of the present invention. The axis Y represents the stacking of the apparatus, which depends on the number of plates 300 stacked and the dimensions of the columns 200. The axis Z represents the width of the apparatus, which corresponds to the width of the plates 300.

The apparatus optionally comprises a closure means constituted by lateral bars 400 that are connected to the edge of the plates in a sealed manner.

Such an apparatus 100 is configured to allow at least one material transfer and one indirect heat exchange between two fluids.

For example, the apparatus can thus be configured to allow an exchange of material and heat between a liquid that circulates in the apparatus in a first direction and a gas that circulates in the apparatus in a second direction. It is understood that any other process for exchanging material and heat between two fluids can be implemented by the apparatus 100 according to the invention without departing from the context thereof. For example, the apparatus 100 can be configured to implement a scrubbing process and/or a distillation process.

The apparatus can allow contact, for the heat and material exchange, between a gas phase rising along the axis of the apparatus and a liquid phase descending under gravity.

The apparatus can also contain the operating pressure by virtue of the brazed mechanical connections between plates and lateral bars.

In any case, the apparatus 100 according to the invention comprises at least one intake for the first fluid, for example a liquid intake, and at least one intake for the second fluid, for example a gas intake, these fluid intakes not being shown in the figures described here.

Each column 200 comprises four walls 202 surrounding a space 204 that is open at both ends so as to allow fluid to pass through the column in the lengthwise direction. No fluid can pass through the four walls.

The column contains a means for transferring mass and heat. This means can be a structured or random packing.

Packing is understood to mean any type of structure that makes it possible to obtain a significant contact surface for contact between a liquid phase and a gas phase and thus to improve the exchanges between the liquid phase and the gas phase.

The contact surface of this packing is larger than the contact surface constituted by the internal walls of the columns 200, preferably much larger.

Disordered irregular stacks of individual elements having specific shapes, for example rings, spirals, etc., are called random packings. Exchanges of heat and/or of material are carried out with the aid of these individual elements. These individual elements can be made of metal, ceramic, plastic or similar materials. “Packed Bed Columns” by N. Kolev, Elsevier, 2006, pp 154-161, describes exemplary individual elements for random packing.

Random packing offers advantageous qualities in terms of transfer efficiency, low pressure drop and simplicity of installation. It comprises, for example. Raschig rings, Pall rings, beads, spiral prismatic packings. Other types of packing are of course conceivable, such as structured packings, which are more complex to implement, or metal foam.

The use of random packings is particularly recommended since it makes it possible to have within reach a source of readily commercially available packing that can be chosen so as to have very specific characteristics or can be bought in large quantities at low cost for standardized apparatuses. These packings are readily commercially available and can be ordered in large quantities, at low cost and with dimensions and geometries corresponding to their role in the apparatus. This makes it possible both to standardize apparatuses so as to simplify their manufacture and reduce the costs thereof, and also to dimension other apparatuses with greater precision if the needs of the customer are more specific.

Preferably, the column is entirely filled by the packing.

The plates, the columns and the mass and heat transfer means are preferably made of metal, for example aluminum or titanium. The packing can be made of stainless steel or a material that is more compatible with oxygen such as copper, nickel, Inconel®, Monel®, etc.

The plate of each pair of adjacent plates is contiguous with the columns between the pair of plates and the columns in the space between the pair of plates are contiguous with one another.

Preferably, the columns are not coated with brazing material, but they can be. It is the sheets known as separator sheets 300 that are generally coated with braze on both sides.

Preferably, the space between two adjacent plates has a width that is substantially equal to one of the small dimensions of the exchange column, such that each column touches two adjacent plates, even before the brazing operation.

Each column of a zone C can be separated from the column of the adjacent zone D by distribution or separation means 220, in contact with the adjacent plates 300.

Preferably, as illustrated, the distribution means are common to the four columns of an alignment 208 between two plates 300. By contrast, the distribution means are disposed in the spaces between two plates 300 and do not cross the plates.

Once the plates, the columns pre-filled with packing and the distribution means have been put in place, the apparatus is placed in a furnace in an inert or reducing atmosphere and is brazed in order to secure the columns and the distribution means to the plates.

The temperature of the furnace is chosen such that the columns are each secured to two plates on opposite sides, and this is sufficient for the apparatus to subsequently form a block.

By contrast, the packings are not negatively affected by the brazing operation, such that a fluid introduced into the columns can be separated by a series of steps of condensation and vaporization on the packings of the columns. Likewise, the columns are not brazed to one another.

The maximum temperature experienced by the apparatus during brazing is lower than the melting point of the plates, a plate being considered to be separate from its braze coating, lower than the melting point of the columns and preferably lower than the melting point of the material and heat exchange means.

Brazing creates a metallic bond between the plates and the columns and distribution means in contact with the plates. The use of columns with a polygonal section can make it possible to have a large contact surface in common with the plates and thus better cohesion of the apparatus.

The columns do not need to be attached to one another before the brazing step, and this considerably simplifies the manufacture of the apparatus.

These are preferably isolated columns, each one independent of the others. Their dimensions and the means for introducing fluids into the columns are chosen so as to limit the inflows of gas or liquid toward the plates.

The distribution means are also secured to the plates by the brazing operation and are not fastened to the columns or to the plates before the brazing operation.

It is preferable for the fluid that is to be separated or mixed to be introduced into each of the columns, and the apparatus comprises means for introducing a fraction of the fluid into each of the columns of one of the zones A, C or D, preferably into the lower part of zone D.

The fluid that is to be separated or mixed is sent only into the columns and is not directly in contact with the plates.

Next, the fluid to be separated becomes enriched in its lightest component, rising through the packings of each column and passing from one zone of columns to the one above.

As will be described in greater detail below, each column 200 comprises at least one peripheral wall 202 that delimits an internal volume of the column 200 in question.

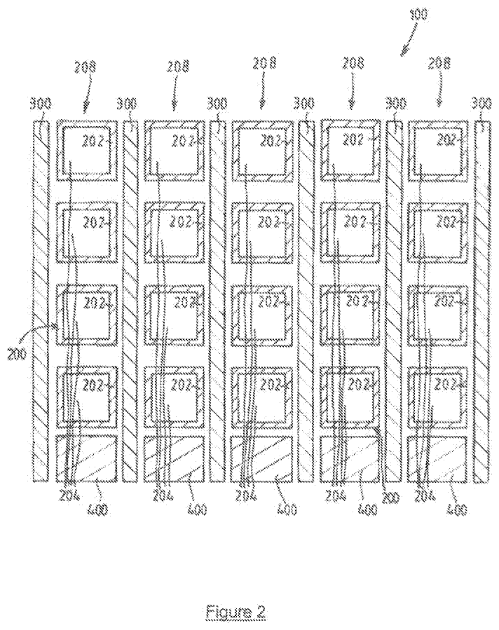

More specifically, each peripheral wall 202 comprises at least one external face 211 via which it is juxtaposed with another column 200, i.e. with the external face of the peripheral wall of this other column, and an internal face 212, which is for example visible in FIG. 2, which delimits this internal volume. At least one material and heat exchange means 230—also shown in FIG. 2—is arranged in this internal volume.

Advantageously, at least one material and heat exchange means is arranged in each column 200, each of these exchange means being received in a compartment 204 of the column 200 in question, each compartment 204 being at least partially delimited at the top by at least one distribution device 220. These distribution devices 220 are configured to ensure an even distribution of at least the first fluid, advantageously of the first fluid and the second fluid, over the one or more material and/or heat exchange means. It is understood that this homogenization makes it possible to promote material and heat exchanges that take place in these exchange means.

According to the example illustrated in FIG. 1, the apparatus 100 comprises three distribution devices 220, thus dividing the apparatus into four zones. It is understood that this is only one particular exemplary embodiment of the present invention and that this example in no way limits the present invention.

These four zones can operate at different pressures and/or have different functions. For example, zone A can operate at 6 bar and zones C and D at a pressure of 1.4 bar.

Advantageously, the elements disposed in the apparatus 100 are brazed together during the brazing operation that allows the columns 200 to be secured to one another. In other words, the material and/or heat exchange apparatus 100 is completely assembled in a single step.

After brazing, if the apparatus has to operate at a temperature that is very low or very high relative to ambient temperature, it can be coated with insulation. Otherwise, the apparatus can be disposed inside an insulated chamber.

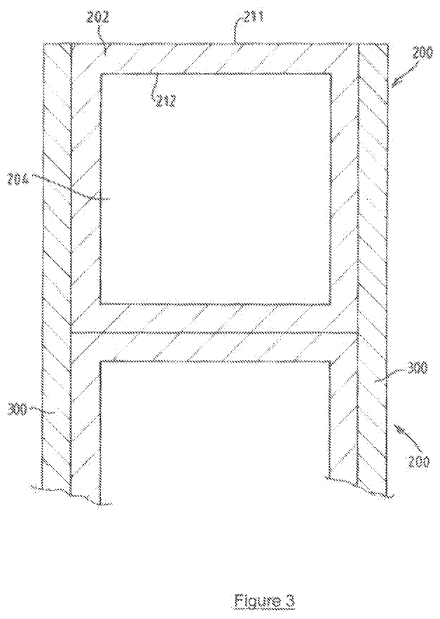

With reference to FIG. 2 and FIG. 3, an exemplary exchange column of an apparatus according to the invention, containing a material and/or heat exchange means and its arrangement in the apparatus will now be described in greater detail. These FIGS. 2 and 3 partially illustrate a horizontal cross section, i.e. a cross section taken on a plane in which the main axis X of extension of the columns 200 is inscribed, of FIG. 1.

FIG. 2 illustrates an exemplary embodiment of the present invention in which showing the twenty columns of a zone of the apparatus. The dimensions of the spaces between columns 200 and between a column and a plate are exaggerated for better appreciation that each column 200 is individual and is not attached either to the adjacent plate or to the neighboring columns before brazing. The dimension of the plates 300 is also exaggerated since, in general, it will be about 1 mm whereas the square tubes 202 will have centimeter-scale dimensions and thicknesses of a few millimeters depending on the requirements in terms of mechanical compression strength at high temperature during the phase of brazing in a furnace and in terms of mechanical ability to withstand pressure during use of the apparatus.

In this example, the apparatus is divided into a series of zones, but the apparatus can, in absolute terms, comprise only a single zone, in which case the length of the columns is practically that of the plates.

In the most probable case, in which the apparatus comprises a plurality of zones, the columns will have a length at most equal to that of the extent of the zone in the direction of the length of the plate.

It can be seen that, between each pair of plates 300, there is an alignment of four columns 200 of square section with four walls 202 having a length that can be equal to the length of the plate or equal to a fraction of the length of the plate.

FIG. 3 shows a part of the zone in FIG. 2 after the brazing process. It can be seen that the column 200 is sandwiched between two plates 300 coated with brazing materials. Two opposite walls of the walls 202 of the column 200 are each connected to an opposite plate 300. The two other opposite walls 202 are contiguous with the walls of the adjacent columns or of the adjacent column and of the closure bar. The interior 204 of the column contains at least one means of promoting material and heat exchange, such as a random packing.

FIGS. 1, 2 and 3 essentially describe a method of assembling the apparatus by brazing. It is also possible to produce such an apparatus using another assembly method or a combination of assembly methods such as brazing, riveting, adhesive bonding or welding. By way of example, it is possible to produce section B alone by brazing and join it by welding to sections A, C and D that would also have been produced by welding.

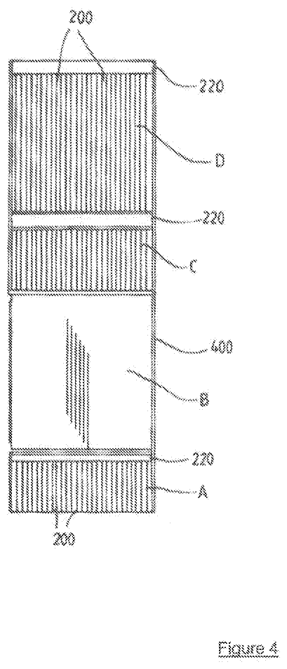

FIG. 4 illustrates a cross section of an apparatus according to the invention that is capable of being used for the distillation of air, for example. The cross section corresponds to that on line A-A in FIG. 1, even if the example in FIG. 4 uses rows of columns between two plates with far more columns than the four in FIG. 1. The direction of the stack of the plates 300 goes into the page (axis Y).

Twenty-eight columns 200 are aligned in the space between the same two adjacent plates for each of the zones A, C, D, zone B not containing columns 200. The same is true for each pair of plates of the stack of plates. Zone A corresponding to the medium-pressure column is supplied via its bottom end such that the cooled gas mixture to be separated, in this case air, is sent to each of the columns 200 of zone A. The air rises in the columns, becoming enriched in nitrogen and depleted in oxygen as it passes through the random packings in the interior 204 of each column. It is possible that a small minority of the columns are not supplied with air, without departing from the invention. Next, the gas travels via the distribution means 220 so as to pass into zone B. Zone B is supplied with liquid oxygen descending from zone C through a distribution means. Zone B comprises the alternating passages for oxygen vaporization and nitrogen condensation, each passage being used either for vaporization or for condensation and the heat traveling through the plates 300 delimiting the passages.

The liquid nitrogen distributed by the distribution means 220 drops back into the columns of zone A so as to act as reflux.

The gaseous oxygen rises into zone C. Zone C is also supplied from above with an oxygen-enriched liquid coming from the lower part of zone A. Condensed nitrogen coming from the condenser B is also sent to the distribution means 220 above zone D.

The liquids sent to zones D and C are separated in these zones by distillation so as to produce a nitrogen-rich gas withdrawn from the columns 200 of zone D and an oxygen-rich liquid is taken from the columns 200 of zone C.

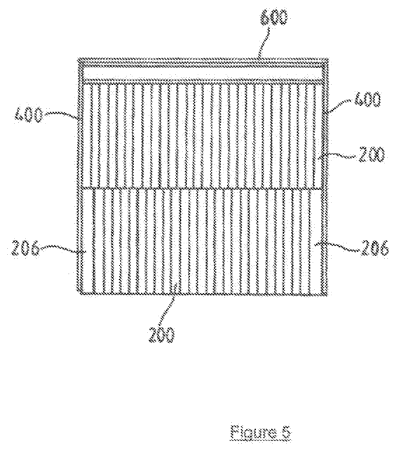

FIG. 5 shows that the columns 200 do not necessarily have the same length as the extent of the zone in the direction of the length of the plate 300. The illustrated zone can be one of zones A, C or D.

In this case, the columns 200 have a length equal to half the dimension of the zone in the vertical direction. The top columns 200 are offset with respect to those below by installing columns of rectangular section 206 on either side of the group of columns 200 of square section.

This allows greater liquid and gas agitation within a zone, since the liquids and gases do not remain in a single column while passing through the zone.

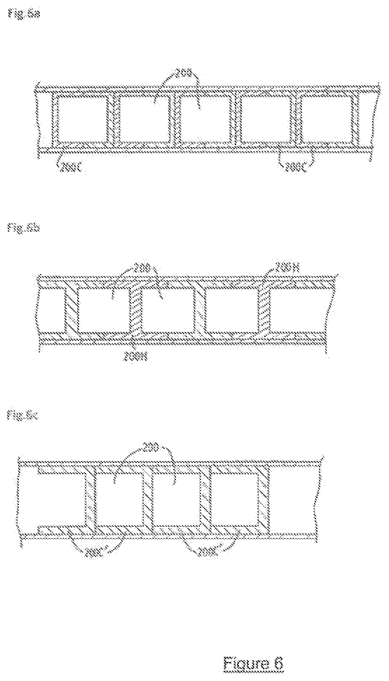

FIG. 6 illustrates a possible alternative construction for the columns 200. As illustrated in FIG. 4, they can be formed by tubes with a square section that are laid alongside one another. It is also possible to form columns using tubes with a rectangular section. Another possibility is to juxtapose open structures so as to form columns, each column having walls belonging to two different elongate elements.

Thus, in FIG. 6a, the columns are formed by elements 200C having a C-shaped section, with the two ends of the section of an element touching the two ends of the section of the adjacent element.

In FIG. 6b, the columns are formed by elements 200H having an H-shaped section, with two ends of the section of an element touching two ends of the section of the adjacent element.

In FIG. 6c, the elements 200C having a C-shaped section are disposed with the bottom of the element touching the ends of the element that is alongside.

It is possible to envisage disposing brazing material on the parts of the elements that have to come into contact in order to strengthen the columns during brazing of the matrix.

Thus, the group of hollow columns is constituted by a grouping of elements hat each form part of two hollow columns.

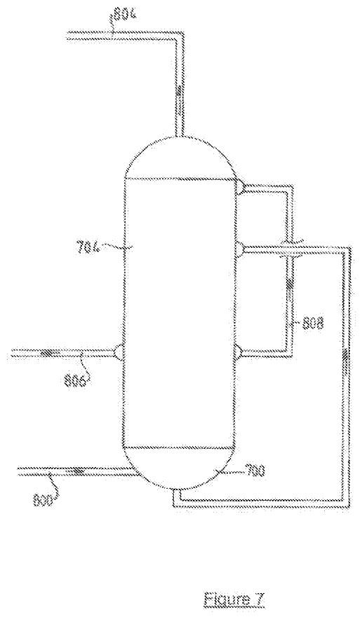

FIG. 7 shows the apparatus in FIG. 1 in a state of use, the face 704 being the last plate of the stack (therefore in the plane XZ).

Air enters via the duct 600 into a half cylinder 700 capping the lower face of the block 100. Air rises in all the columns 200, the pressure and the flow rate being chosen so as to make it possible to supply all the columns without using particular means in the half cylinder to make the distribution of air easier. An oxygen-enriched liquid descends from zone A to the bottom of the half cylinder 700. This liquid is sent via the duct 800 toward zone D. A nitrogen-enriched liquid is sent from the top of zone A via the duct 808 toward the top of zone D.

An oxygen-rich product, which can be a gas or a liquid, is withdrawn via the duct 806.

A nitrogen-rich gaseous product arrives from all the columns 200 of zone D toward a half cylinder 700 capping the top face of the block 100 and is withdrawn via the duct 804.

The fluid intakes and outlets are located level with a distribution means 220 allowing the fluid to be distributed, by means of a half cylinder, over each column of each row of columns, or allowing a fluid coming from each column of each row of columns to be collected. The distribution means 220 are situated on either side of each plate and do not allow a fluid to pass from one side of a plate to the other.

In order to insulate the apparatus, the latter can be contained in a conventional cold box containing perlite, or otherwise solid insulation can coat the walls of the apparatus and, in this case, no chamber is required to enclose the insulation.

It will be understood that many additional changes in the details, materials, steps, and arrangement of parts, which have been herein described and illustrated in order to explain the nature of the invention, may be made by those skilled in the art within the principle and scope of the invention as expressed in the appended claims. Thus, the present invention is not intended to be limited to the specific embodiments in the examples given above and/or the attached drawings.

1.-12. (canceled)

13. A direct heat exchange and material transfer apparatus comprising a plurality of columns, a single stack of at least two solid metal plates of rectangular section, the plates being substantially all of the same shape and dimensions and parallel to a determined direction, each plate being separated from the adjacent plate, at least in a first direct heat exchange and material transfer zone of the apparatus, by a group of hollow metal columns that are aligned and have a section which is polygonal and has at least two parallel surfaces, the channels being parallel to the determined direction and contiguous with one another, the columns of each group each being in contact with the two metal plates on either side of the group, at least some of the columns of a group containing a material and heat exchange means.

14. The apparatus as claimed in claim 13, wherein the plates are secured to the columns by brazing or by adhesive bonding.

15. The apparatus as claimed in claim 13, wherein the plates and the columns are formed i) of the same metal or ii) of the same alloy or iii) of alloys with the same main metal.

16. The apparatus as claimed in claim 13, wherein the plates and/or the columns and/or the direct and/or indirect heat exchange and material transfer means is/are made of one of the following metals: aluminum, stainless steel, nickel, copper or titanium.

17. The apparatus as claimed in claim 13, wherein the minimum dimension of an edge of the section of a column is greater than 2 cm.

18. The apparatus as claimed in claim 13, wherein the length of a plate is at least equal to 1 m.

19. The apparatus as claimed in claim 13, wherein the first zone constitutes a part of the apparatus that is delimited by the width and the thickness of the stack and by a part of the length of the stack.

20. The apparatus as claimed in claim 13, further comprising a means for supplying at least two thirds of the columns of at least the first zone with the same fluid.

21. The apparatus as claimed in claim 13, further comprising a means for collecting the same fluid from at least two thirds of the columns of at least a first zone.

22. An apparatus for separation, for use at temperatures below 0° C., comprising a heat and material exchange apparatus as claimed in claim 13, the apparatus being oriented such that, in use, a liquid introduced into a column flows in each column under gravity, a means for sending a fluid to be separated to the exchange body comprising at least two components, a means for extracting, from at least one end of the apparatus, at least one separated fluid enriched in one of the components of the fluid to be separated, and a means for insulating the exchange apparatus.
